(19) United States
(12) Patent Application Publication
(10) Pub. No.: US 2014/0298007 A1
(43) Pub. Date: Oct. 2, 2014

(54) NETWORK SWITCH CONFIGURATION

(71) Applicant: Hewlett-Packard Development Company, L.P., Houston, TX (US)

(72) Inventors: Suresh Rukmangathan, Bangalore (IN); Vasudeva Nagaraja, Bangalore (IN)

(73) Assignee: Hewlett-Packard Development Company, L.P., Houston, TX (US)

(21) Appl. No.: 13/897,094

(22) Filed: May 17, 2013

(30) Foreign Application Priority Data
Mar. 28, 2013 (IN) 1394/CHE/2013

(51) Int. Cl. H04L 29/06

(52) U.S. Cl. CPC H04L 63/0876
USPC 713/153

(57) ABSTRACT

Provided is a method of configuring a network switch. A configuration file is allowed to be edited on a server. The compatibility of the configuration file with a network switch is validated on the server. The configuration file is encrypted and applied to the network switch.

CLAIM FOR PRIORITY

The present application claims priority under 35 U.S.0 119 (a)-(d) to Indian Patent application number 1394/CHE/2013, filed on Mar. 28, 2013, which is incorporated by reference herein in its entirety.

### BACKGROUND

A network switch, commonly referred to as just a switch, is a network device that links network segments or network devices. Network switches exist for various types of networks such as Ethernet, Fibre Channel, Asynchronous Transfer Mode (ATM), etc. Switches can be broadly classified into two types: unmanaged switches and managed switches. Unmanaged switches have no configuration interface or options. They are typically plug and play devices. On the other hand, managed switches can be modified or managed in different ways such as through a command-line interface (CLI) accessed via a serial port, a Simple Network Management Protocol (SNMP) agent, or a web-based interface.

### BRIEF DESCRIPTION OF THE DRAWINGS

For a better understanding of the solution, embodiments will now be described, purely by way of example, with reference to the accompanying drawings, in which:

FIG. 1 is a block diagram of a system for configuring network switches, according to an example.

FIG. 2 illustrates a method of configuring network switches, according to an example.

### DETAILED DESCRIPTION OF THE INVENTION

Network switches are typically manufactured and sold with default configurations. The default configuration parameters of a switch can be modified by an end user as per his requirements. Some examples of configuration parameters of a switch which could be modified by a user include assignment of an IP address, VLAN configuration, configuration of the switch management interface, default gateway configuration, and support for HTTP access.

The configuration settings related to a switch can be stored in a configuration file(s). The configuration files help in switch configuration and can contain some or all of the commands required to configure a switch. The configuration settings with respect to a switch are maintained in a machine-readable format which is understood by the switch without the need for excessive computation. A human-readable configuration, which is easily understood by a user, is obtained by translating the machine-readable format as when the user makes a request or issues a command to see the configuration. Hence, often a translation is required from the machine-readable format to the human-readable format, for example, when a user chooses to see a particular configuration via a Command Line Interface (CLI) command or during downloading of a configuration onto a switch. This translation adds a significant overhead to the download operation and tends to delay the same. Such delays become longer if the size of a configuration file increases since more data needs to be processed and translated.

Another issue with a network switch configuration relates to the validation of a configuration file. Network switch manufacturers typically provide support for downloading an external configuration file onto a switch, but do not allow users to edit a configuration off the switch. A user has no way of determining beforehand what the behavior of a switch would be if an external configuration is downloaded to the switch. In other words, a user can not be certain that a configuration would work on a switch until it is applied to the switch. Needless to say, this hit and trial method could cause a considerable delay before a user could find a correct configuration file. A further issue with a network switch configuration relates to the issue of an upgrade/downgrade or a backward/forward compatibility of a configuration file with a network switch. Even with extensive checks in place, upgrade/downgrade issues may develop into a new switch firmware causing such issues to manifest at a customer site.

Proposed is a solution that allows editing, validation, and translation of a configuration file on a server. A validated and translated configuration file is the encrypted and transferred to a target network switch for application.

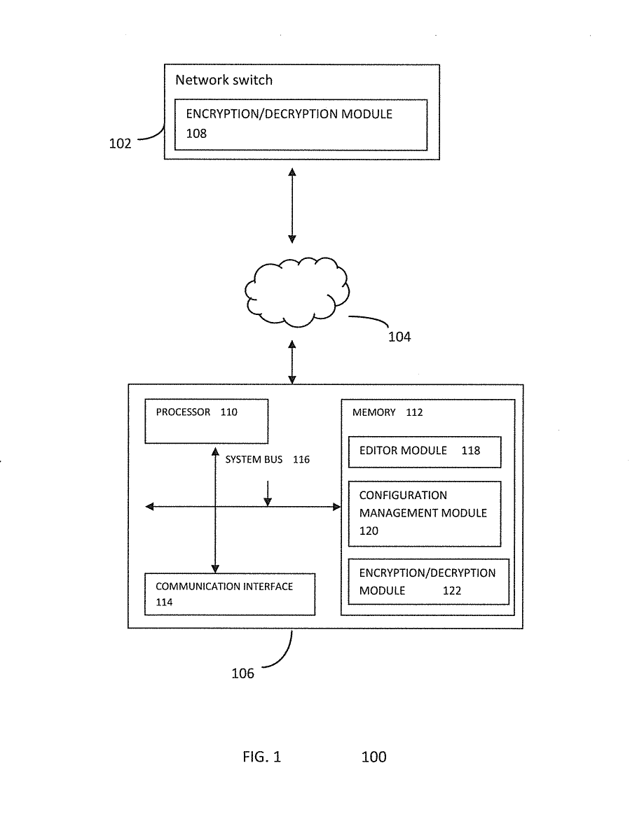

FIG. 1 is a block diagram of a system 100 for configuring network switches, according to an example. System 100 includes network switch 102, network 104, and server 106. Components of system 100 i.e. network switch 102 and server 106 could be operationally connected over network 104, which may be wired or wireless. Network 104 may be a public network such as the Internet, or a private network such as an intranet. It would be appreciated that the components depicted in FIG. 1 are for the purpose of illustration only and the actual components (including their number) may vary depending on the computing architecture deployed for implementation of the present invention.

Network switch 102 could be of different types. On the basis of form, network switch 102 may be a rack mounted switch, chassis switch, catalyst switch, etc. On the basis of configuration, network switch 102 may be a managed switch, an unmanaged switch, a smart or an enterprise managed switch. In an implementation, network switch includes encryption/decryption module 108. Encryption/decryption module 108 performs decryption of an encrypted configuration file (or configuration settings). In an implementation, an encrypted configuration file is received from a computer server. Encryption/decryption module 108 may also carry out encryption of a configuration file (or configuration settings) present on a network switch. In an implementation, an encrypted configuration file is transferred to a computer server for editing.

Computer server 106 is a computer or computer application (machine executable instructions) that provides services to other computers or computer applications. Computer server 106 may include a processor 110, a memory 112, and a communication interface 114. The components of computer server may be coupled together through a system bus 116. Processor 110 may include any type of processor, microprocessor, or processing logic that interprets and executes instructions. Memory 112 may include a random access memory (RAM) or another type of dynamic storage device that may store information and instructions non-transitorily for execution by processor.

In an implementation, memory 112 includes editor module 118, configuration management module 120 and encryption/decryption module 122. Editor module 118 allows editing of a network switch's configuration data (for instance, in a configuration file) on the computer server. In an implementation, an end-user can use editor module 118 to edit or define configuration settings related to a network switch on the computer server. Some non-limiting examples of editor module 118 may include a text editor or word processor application. Configuration management module 120 is involved in validating the compatibility of a configuration file with a network switch on the server. Configuration management module 120 may also translate configuration file to a machine-readable format recognizable by a network switch. Encryption/decryption module 122 performs encryption of a configuration file (or configuration settings) related to a network switch on the computer server.

Communication interface 114 may include any transceiver-like mechanism that enables computer server 106 to communicate with other devices and/or systems via a communication link. Communication interface 114 may be a software program, a hard ware, a firmware, or any combination thereof. Communication interface 114 may use a variety of communication technologies to enable communication between computer server and another computing device. To provide a few non-limiting examples, communication interface may be an Ethernet card, a modem, an integrated services digital network (“ISDN”) card, a network port (such as a serial port, a USB port, etc.) etc.

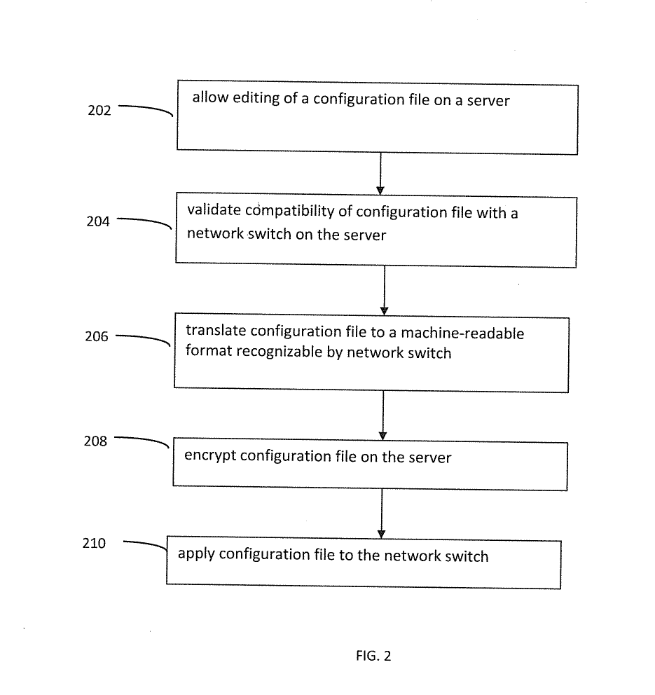

FIG. 2 illustrates a method of configuring network switches, according to an example. At block 202, editing of a network switch's configuration data is allowed on a computer server. In an implementation, a network switch's configuration data may be present in the form a configuration file. In such case, a configuration file containing configuration data or settings related to a network switch is allowed to be edited by a user on a computer server.

A configuration file related to a network switch may preexist on the computer server or received by the computer server from an external source such as, but not limited to, a network switch. Thus, the computer server may receive a configuration file related to a network switch from the switch itself, for instance a user may upload a configuration from a network switch to the computer server for editing. It may be noted that the term “user” may be read as to include an end-user of a network switch as well.

In an implementation, a text editor or word processor application such as Microsoft Word, WordPerfect, Notepad, etc. may be used on the computer server, for editing or defining configuration data or settings (or a configuration file containing such settings) related to a network switch. Thus, configuration data (or configuration file) related to a network switch may be in a human-readable format which a user can understand.

In an instance, once a configuration file (or configuration settings) has been edited, the edited configuration file is stored in a repository on the computer server. The repository may store an unedited version or multiple versions of a configuration file (generated during various stages or periods of editing) as well.

At block 204, once a configuration file related to a network switch has been edited, the configuration file is validated for compatibility with the network switch on the computer server. In other words, a determination is made whether the modified or new configuration settings (or the edited configuration file) would be compatible with the network switch for which the edited configuration settings (or configuration file) are intended.

In an implementation, a configuration management module on the computer server may perform the validation function referred above. The configuration management module may check the compatibility of modified or new configuration settings (or the edited configuration file) with a destination platform of a network switch. The configuration management module may perform the required validations and report errors, if any. In an instance, a validation is performed by first checking the semantics of each command in the configuration file, and then checking for interdependencies. The hardware platform for which the user intends to import/export the configuration to/from could be determined via an identification which is generally present in configuration file headers, or it can be directly supplied by a user. The configuration management module can then resolve hardware dependant attributes like ports using the available hardware information.

At block 206, the configuration file (or configuration settings) is/are translated or converted to a machine-readable format which is recognizable by the network switch for which it is intended. Since at the time of editing of a network switch configuration file (or configuration settings), the data therein may be in human-readable form, at this stage the network switch configuration file (or configuration settings) is/are converted into a machine-readable format which is understandable by a target network switch to which such settings or file may be applied. The aforesaid translation or conversion takes place on the computer server.

In an implementation, to support backward and forward compatibility, various versions of the configuration schema can be maintained by the configuration management module in, for instance, an Extensible Markup Language (XML) format. Knowing the versions of the input and output configurations, the configuration management module can use the XML format schemas as an input, and perform backward or forward compatibility conversions as required.

At block 208, the configuration file (or configuration settings) related to the network switch is/are encrypted. In an implementation, the encryption is performed by an encryption/decryption module on the computer server. A variety of encryption/decryption applications are available which could be used for performing the encryption of an edited configuration file (or configuration settings). Encryption schemes such as symmetric-key encryption and public-key encryption can be used for encryption.

At block 210, the encrypted configuration file (or configuration settings) is/are applied to the network switch. In an instance, a user-edited configuration file is applied to a network switch for which it was validated at block 204.

In an implementation, applying a configuration file to a network switch comprises transferring or transmitting the encrypted configuration file from the server to the network switch. Transferring of a configuration file may take place, for instance, by copying the encrypted configuration file to a portable storage medium such as a USB drive, and then copying the encrypted configuration file from the portable storage medium to the target network switch. On the other hand an encrypted configuration file may be transferred from the server to a selected network switch through a network.

Applying a configuration file to a network switch may also include applying configuration settings or configuration data in the encrypted configuration file to a network switch. This may first involve decryption of the encrypted configuration file (or configuration settings) on the network switch to which the configuration file (or configuration settings) is/are being applied. An encryption/decryption module on the network switch may perform the decryption of the encrypted configuration file (or configuration settings). Once an encrypted configuration file is decrypted, configuration settings presented therein may be applied to the network switch.

The proposed solution aims at reducing the time taken and effort involved for users to edit a switch configuration, and its application to a switch. A user would be able to extract a configuration from the switch and edit it as required. Following which, the user can use an external service to get it validated and certified for the platform that she/he is trying to apply it to. After the validation and certification process, the user obtains a configuration file in a format such that the switch need not translate it from the human- readable format to the machine-readable. As a result, the download and application of the configuration file is faster.

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system.

It would be appreciated that the system components depicted in the illustrated figures are for the purpose of illustration only and the actual components may vary depending on the computing system and architecture deployed for implementation of the present solution. The various components described above may be hosted on a single computing system or multiple computer systems, including servers, connected together through suitable means.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

1. A method of configuring a network switch, comprising:
allowing editing of a configuration file on a server;
validating compatibility of the configuration file with the network switch on the server;
encrypting the configuration file on the server; and
applying the configuration file to the network switch.

2. The method of claim 1, further comprising translating the configuration file to a machine-readable format recognizable by the network switch.

3. The method of claim 1, further comprising decrypting the configuration file at the network switch prior to applying the configuration file to the network switch.

4. The method of claim 1, wherein allowing editing of the configuration file on the server comprises allowing a user to edit or define configuration data related to the network switch on the server.

5. The method of claim 1, wherein applying the configuration file to the network switch comprises transmitting the encrypted configuration file from the server to the network switch.

6. The method of claim 1, wherein applying the configuration file to the network switch comprises applying configuration data defined in the configuration file to the network switch.

7. The method of claim 1, wherein the configuration file is obtained from the network switch.

8. The method of claim 1, further comprising translating the configuration file from a human-readable format to a machine-readable format recognizable by the network switch.

9. A system for configuring a network switch, comprising:
an editor module to edit a configuration file related to the network switch ; and
a configuration management module to validate compatibility of the edited configuration file with the network switch;
an encryption module to encrypt the edited configuration file; and
a communication interface to transmit the edited configuration file to the network switch.

10. The system of claim 9, further comprising a repository to store the edited is configuration file.

11. The system of claim 9, further comprising a communication interface to transfer the encrypted configuration file to an external storage medium.

12. The system of claim 9, wherein the configuration file is received from an external source.

13. The system of claim 12, wherein the external source is the network switch.

14. The system of claim 9, wherein the configuration module converts the edited configuration file to a machine-readable format recognizable by the network switch.

15. A non-transitory processor readable medium, the non-transitory processor readable medium comprising machine executable instructions, the machine executable instructions when executed by a processor causes the processor to:
allow editing of a configuration file related to a network switch;
translate the configuration file to a machine-readable format recognizable by the network switch;
validate compatibility of the configuration file with the network switch;
encrypt the configuration file; and
transmit the configuration file to the network switch.
